(19) United States
(12) Patent Application Publication
(10) Pub. No.: US 2010/0295768 A1
(43) Pub. Date: Nov. 25, 2010

(54) Electronic paper display device and manufacturing method thereof

(75) Inventors: Jeong Bok Kwak, Suwon-si (KR); Hwan Soo Lee, Suwon-si (KR); Hye Yeon Cha, Yongin-si (KR); Sang Moon Lee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/461,129

(22) Filed: Jul. 31, 2009

(30) Foreign Application Priority Data
May 21, 2009 (KR) 10-2009-0044406

(51) Int. Cl. G09G 3/34; H01J 9/00

(52) U.S. Cl. 345/107; 445/24

(57) ABSTRACT

The present invention relates to a paper display device and a manufacturing method thereof. The electronic paper display device includes: a first electrode; a first partition wall which is disposed on the first electrode, and defines a number of cell regions; a second partition wall which faces the first partition wall, and defines the cell regions together with the first partition wall; a substrate including a second electrode, wherein the second electrode is disposed on the second partition wall, and faces the first electrode; dielectric fluid filled in at least each of the cell regions; and twist balls individually floating within the dielectric fluid of each of the cell regions.

### CROSS-REFERENCE TO RELATED APPLICATIONS

This application claims the benefit of Korean Patent Application No. 10-2009-0044406 filed with the Korea Intellectual Property Office on May 21, 2009, the disclosure of which is incorporated herein by reference.

### BACKGROUND OF THE INVENTION

1. Field of the Invention

The present invention relates to an electronic paper display device and a manufacturing method thereof; and, more particularly, to an electronic paper display device including partition walls corresponding to each of a first electrode and a second electrode, and a manufacturing method thereof.

2. Description of the Related Art

A widely used next generation display apparatus includes a Liquid Crystal Display (LCD), a Plasma Display Panel (PDP), an organic electro luminescence display, and an electronic paper display device, and so on.

The electronic paper display device among these apparatuses is flexible, and is more inexpensive than other display apparatuses in terms of a production cost.

Since the electronic paper display apparatus does not require background light or continuous recharge, it can be driven using a very small amount of energy, and accordingly, its energy efficiency is remarkably excellent.

Also, the electronic paper display device can not only provide clear image quality and wide field of view, but also incorporate a memory function in which to allow displayed characters and images not to be completely vanished even if the power is momentarily shut off. Therefore, the electronic paper display device is expected to be widely used in extensive fields of collapsible screens, and electric wall paper, including print media such as books, newspapers, or magazines.

Meanwhile, a technical scheme of implementing the electronic paper display device is classified into a liquid crystal-based scheme, an organic Electro-Luminescent (EL) scheme, a reflective type display scheme, an electrophoretic scheme, a twist ball scheme, an electrochromic scheme, and a mechanical reflective display scheme, which have been developed.

Among these, an electronic paper display device using the twist balls includes two electrodes and an elastomer sheet interposed between the two electrodes. Herein, twist balls having optical and electrical anisotropy are attached to the elastomer sheet. In this case, dielectric fluid is coated on an outer surface of the twist ball. Herein, the twist ball may include a black hemisphere and a white hemisphere which are charged with different charges. When a voltage is applied to the two electrodes, hemispheres of each particle are rotated in the dielectric fluid to face electrode surfaces having polarities opposite to each other according to the direction of the applied voltage, so that the electronic paper display device using the twist balls can display black and white colors.

In this case, in order to form the electronic paper display device, it is necessary to separately coat the dielectric fluid on the outer surface of the twist ball, which causes complexity of processes.

Further, as the twist balls having the dielectric fluid coated thereon are adhered on the elastomer sheet through the application scheme, the twist balls fail to be uniformly arranged on the elastomer sheet, and some areas are formed in which the twist balls are overlapped with each other or are not disposed, thereby resulting in reduction of a contrast ratio of the electronic paper display device.

Furthermore, as the twist balls are rotated while being moved at the time of driving electronic paper display device, lamination between twist balls may be generated, thereby resulting in reduction of its contrast ratio.

Therefore, the conventional electronic paper display device using twist balls has posed a problem of causing not only complexity of manufacture processes, but also reduction of the contrast ratio and inferior image quality which are caused by reduction in uniform alignment of the twist balls.

### SUMMARY OF THE INVENTION

The present invention has been invented in order to overcome the above-described problems and it is, therefore, an object of the present invention to provide an electronic paper display device having partition walls corresponding to each of a first electrode and a second electrode, and a manufacturing method thereof.

In accordance with one aspect of the present invention to achieve the object, there is provided an electronic paper display device including: a first electrode; a first partition wall which is disposed on the first electrode, and defines a number of cell regions; a second partition wall which faces the first partition wall, and defines the cell regions together with the first partition wall; a substrate including a second electrode, wherein the second electrode is disposed on the second partition wall, and faces the first electrode; dielectric fluid filled in at least each of the cell regions; and twist balls individually floating within the dielectric fluid of each of the cell regions.

Herein, the electronic paper display device further includes a first buffer layer disposed on the first electrode of each of the cell regions, wherein the first buffer layer is integrated with the first partition wall.

Also, the electronic paper display device further includes a second buffer layer disposed on the second electrode of each of the cell regions, wherein the second buffer layer is integrated with the second partition wall.

Also, the electronic paper display device further includes a third partition wall disposed along periphery of the first electrode, wherein the third partition wall has a height higher than that of the first partition wall.

Also, the third partition wall is formed to have the same material as that of the first partition wall.

Also, the first and the second partition walls are separated apart from each other.

Also, the first and the second partition walls are in contact with each other.

Also, the first electrode is formed of a conductive substrate.

Also, the electronic paper display device further includes a substrate disposed on the second electrode.

In accordance with another aspect of the present invention to achieve the object, there is provided a method for manufacturing an electronic paper display device including the steps of: forming a first partition wall and a second partition wall, which define a number of cell regions, on each of a first electrode and a second electrode; injecting twist balls on the first electrode of each of the cell regions defined by the first partition wall; injecting dielectric fluid in at least each of the cell regions including the twist balls; and bonding the first electrode having the first partition wall formed thereon and the second electrode having the second partition wall formed thereon so that the first partition wall and the second partition wall can be faced to each other.

Herein, the first partition wall and the second partition wall are formed through an imprint method.

Also, in the step of forming the first partition wall, a first buffer layer is further formed on the first electrode of each of the cell regions defined by the first partition wall.

Also, in the step of forming the first partition wall, a third partition wall is further formed to have a height higher than that of the first partition wall, wherein the third partition wall is disposed along periphery of the first electrode.

Also, in the step of forming the first partition wall, a first align mark disposed on the third partition wall is further formed.

Also, a second align mark corresponding to the first align mark is formed on the substrate disposed on the second electrode.

Also, in the step of forming the second partition wall, the second buffer layer is further formed on the second electrode of each of the cell regions defined by the second partition wall.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view illustrating an electronic paper display device in accordance with a first embodiment of the present invention; and

FIGS. 2 to 8 are cross-sectional views illustrating a method of manufacturing an electronic paper display device in accordance with a second embodiment of the present invention.

### DETAILED DESCRIPTION OF THE PREFERABLE EMBODIMENTS

Hereinafter, embodiments of the present invention will be described in detail with reference to the accompanying drawings illustrating a semiconductor package. The following embodiments are provided as examples to allow those skilled in the art to sufficiently appreciate the spirit of the present invention. Therefore, the present invention can be implemented in other types without limiting to the following embodiments. And, for convenience, the size and the thickness of an apparatus can be overdrawn in the drawings. The same components are represented by the same reference numerals hereinafter.

FIG. 1 is a cross-sectional view illustrating an electronic paper display device in accordance with a first embodiment of the present invention.

Referring to FIG. 1, the electronic paper display device in accordance with the first embodiment of the present invention includes a lower substrate 100, an upper substrate 200, a dielectric fluid 300 interposed between the lower substrate 100 and the upper substrate 200, and twist balls 400 floating within the dielectric fluid 300.

In particular, the lower substrate 100 may include a first electrode 110, and a first partition wall 120a disposed on the first electrode 110.

Herein, the first electrode 110 may be formed of a conductive substrate. Herein, as for a material of the first electrode 110, a metal substrate such as Cu, Ag, and so on may be exemplified. Further, the lower substrate 100 may further include a base layer disposed on a lower part of the first electrode 110. For example, the base layer may be formed in the shape of a substrate, such as a plastic substrate and a glass substrate, or a film.

A first partition wall 120a defining a number of cell regions C is disposed on the first electrode 110. The first partition wall 120a may be formed of a transparent material having no effect on image quality. The first partition wall 120a may be formed of thermosetting resin or UV curable resin. For example, the first partition wall 120a may be formed of polyurethane acrylate (PUA), or polydimethylsiloxane (PDMS).

The cell regions C defined by the first partition wall 120a may be formed in a variety of shapes as viewed in a plane, but the present invention is not limited thereto. For example, the cell regions C may have various shapes such as a square shape, a circular shape, a cross shape, and so on.

Moreover, the lower substrate 100 may include a first buffer layer 120b disposed on the first electrode 110 of each of the cell regions C. The first buffer layer 120b functions to prevent leakage of charged charges in the twist balls 400 into the first electrode 110 due to direct contact between the first electrode 110 and the twist balls 400. Herein, the first partition wall 120a may be integrated with the first buffer layer 120b. That is, the first buffer layer 120b may be formed to have the same material as that of the first partition wall 120a.

Further, the lower substrate 100 may further include a third partition wall 120c disposed along periphery of the first electrode 110. The third partition wall 120c may have a height higher than that of the first partition wall 120a. The third partition wall 120c can prevent dielectric fluid 300 from being emitted to an outside. Also, the third partition wall 120c plays a role of allowing the lower substrate 100 and the upper substrate 200 to be separated apart from each other at predetermined intervals. Thus, the twist balls 400 to be described below can be freely rotated at the separation intervals. The third partition wall 120c may be formed at the time of forming the first partition wall 120a. That is, the third partition wall 120c may be integrated with the first buffer layer 120b, and the third partition wall 120c may be formed to have the same material as that of the first buffer layer 120b.

Meanwhile, the upper substrate 200 may include a second electrode 220 disposed on the substrate 210, and a second partition wall 230a disposed on the second electrode 220.

The substrate 210 may be formed of transparent material capable of transmitting lights. For example, the substrate 210 may be formed of polyethyleneterephthalate (PET), polyvinyl alcohol (PVA), polyethylene (PE), polycarbonate (PC), polyacrylate, polymethylmethacrylate, polyurethane, cellulose acetate butyrate (CAB), and so on.

The second electrode 220 is disposed on the lower part of the substrate 210 to face the first electrode 110. Herein, the second electrode 220 may be formed of conductive material, such as ITO, IZO, ITZO, and so on.

The second partition wall 230a is disposed on the lower part of the second electrode 220 to correspond to the first partition wall 120a. Thus, the second partition wall 230a can define a number of cell regions C, together with the first partition wall 120a. The second partition wall 230a may be formed of transparent material having no effect on image quality. The second partition wall 230a may be formed of thermosetting resin or UV curable resin. For example, the second partition wall 230a may be formed of polyurethane acrylate (PUA), or polydimethylsiloxane (PDMS).

Moreover, the upper substrate 200 may include a second buffer layer 230b disposed on the second electrode 220 of each of the cell regions C. The second buffer layer 230b functions to prevent leakage of charged charges in the twist balls 400 into the second electrode 220 due to direct contact between the second electrode 220 and the twist balls 400. Herein, the second partition wall 230a may be integrated with the second buffer layer 230b. That is, the second buffer layer 230b may be formed to have the same material as that of the second partition wall 230a.

The upper substrate 200 and the lower substrate 100 may be bonded to each other by a sealing member 500 interposed therebetween. The sealing member 500 may be disposed on the third partition wall 120c along an edge of the upper substrate 200, but the present invention is not limited thereto. The sealing member 500 is further interposed between the first partition wall 120a and the second partition wall 230a, so that it is possible to improve close adhesion between the upper substrate 200 and the lower substrate 100. Herein, the sealing member 500 may be formed of adhesive resin, for example, UV curable resin.

In this case, the upper substrate 200 and the lower substrate 100 are bonded so that the first partition wall 120a and the second partition wall 230a can face each other. Herein, the first partition wall 120a and the second partition wall 230a may be separated apart from each other. However, the present invention is not limited thereto, and the first partition wall 120a and the second partition wall 230a may come into contact with each other.

Each of the cell regions C defined by the first partition wall 120a and the second partition wall 230a may be filled with the dielectric fluid 300. Herein, when the first partition wall 120a is separated apart from the second partition wall 230a, the dielectric fluid 300 may be interposed between the first partition wall 120a and the second partition wall 230a.

Further, a liquid material, which is capable of converting lights in liquid phase, and has lubricant ingredients, may be used as the dielectric fluid 300, e.g. Dow corning 10, Centistoke 200, and so on.

The twist balls 400 may be individually distributed in the dielectric fluid 300 of each of the cell regions C defined by the first partition wall 120a and the second partition wall 230a. Herein, the twist balls 400 may include a first hemisphere 410 which reflects lights, and a second hemisphere 420 which absorbs lights. Herein, the first hemisphere 410 and the second hemisphere 420 may be charged with a different charge. In this case, as the twist balls 400 is rotated by electric field, which is applied from each of the cell regions C through a dielectric fluid of being an intermediary, it is possible to display characters and images. To be specific, each of the first electrode 110 and the second electrode 220 is connected to a positive electrode and a negative electrode, and electric field is generated due to a voltage applied to each of the electrodes. Then, as the twist balls 400 injected in each of the cell regions C are rotated in the dielectric fluid 300 by the electric field generated between the first electrode 110 and the second electrode 220, the twist balls 400 reflect and absorb lights, and accordingly, characters and images can be displayed.

Herein, the first partition wall 120a and the second partition wall 230a can prevent the twist balls 400 from being moved to neighboring cell regions C during driving of the electronic paper display device. Therefore, it is possible to prevent reduction of a contrast ratio and inferior image quality of the electronic paper display device. Furthermore, the first partition wall 120a and the second partition wall 230a can prevent the twist balls 400 from being moved to neighboring cell regions C during a process for bonding the upper substrate 200 and the lower substrate 100.

In this case, in order to prevent the twist balls 400 injected in each of the cell regions C from being moved to neighboring cells, the cell regions C must have a height higher than a size of the twist balls 400. Thus, the height of the cell regions C is increased in proportion to a size of the twist balls 400. In this case, when a partition wall is formed on only any one of the upper substrate 200 and the lower substrate 100, the height of the cell regions C is determined by the height of one partition wall. In this case, the more aspect ratio of the partition wall, the more the contrast ratio of the electronic paper display device. However, there is a limit in forming the aspect ratio of the partition wall to have a high value owing to limitation of the manufacturing process. That is, in the case where the aspect ratio of the partition wall is formed to be higher than 1.5, the partition wall may be broken or damaged at the time of its formation. To improve this, the aspect ratio of the partition wall is formed to be lower than or equal to 1.5. As such, due to the limitation of the width of the partition wall, i.e. the aspect ratio of the partition wall, according to the height of the partition wall, when a partition wall is formed on only any one of the upper substrate and the lower substrate, a location area where the partition wall occupying in a display region may be increased, and accordingly, the contrast ratio of the electronic paper display device may be reduced.

However, in the present invention, the height of the cell regions C is adjusted by the heights of the first partition wall 120a and the second partition wall 230a provided in each of the upper substrate 200 and the lower substrate 100. Therefore, the width of the first partition wall 120a and the second partition wall 230a provided in each of the upper substrate 200 and the lower substrate 100 may be lower than that of the partition wall provided in only any one of the upper substrate 200 and the lower substrate 100. Thus, even if the size of the twist balls 400 is increased by the first partition wall 120a and the second partition wall 230a, it is possible to prevent reduction of the contrast ratio of the electronic paper display device due to the limitation of the aspect ratio of the partition wall.

In addition, it has been illustrated in the embodiment of the present invention that the first partition wall 120a has the same height as that of the second partition wall 230a. However, the present invention is not limited thereto, and the first partition wall 120a and second partition wall 230a may have a different height.

Therefore, the electronic paper display device in accordance with the embodiment of the present invention is provided with the partition wall, and thus twist balls can be uniformly disposed, thereby resulting in prevention of reduction in the inferior image quality and contrast ratio of the electronic paper display device.

Moreover, the partition wall can prevent the twist balls from being moved during a process for manufacturing the electronic paper display device or during driving of the electronic paper display device, so that it is possible to prevent reduction in inferior image quality or the contrast ratio of the electronic paper display device.

Further, the partition walls are formed on each of the lower substrate and the upper substrate, and thus it is possible to overcome limitation of the aspect ratio of the partition wall, which results in reduction of the contrast ratio through the partition wall.

Furthermore, by filling the dielectric fluid in a region defined by the partition wall, and then allowing twist balls to be distributed in the dielectric fluid, it is possible to simplify a conventional process for coating dielectric fluid on an outer surface of the twist balls.

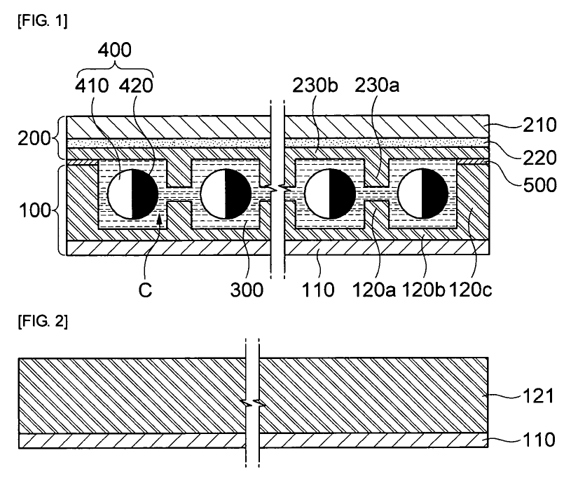

Hereinafter, a description will be given of a method for manufacturing an electronic paper display device in accordance with a second embodiment of the present invention, with reference to FIGS. 2 to 8.

FIGS. 2 to 8 are cross-sectional views illustrating a method of manufacturing an electronic paper display device in accordance with the second embodiment of the present invention.

Referring to FIG. 2, in order to form the electronic paper display device, a resin layer 121 is applied on the first electrode 110.

The first electrode 110 may be formed of a conductive substrate. Herein, as for a material of the first electrode 110, a metal substrate such as Cu, Ag, and so on may be exemplified. In the embodiment of the present invention, the first electrode 110 plays a role of performing a supporting layer as well as an electrode. However, the present invention is not limited thereto, and a base layer of being a separate supporting layer may be further disposed on a lower part of the first electrode 110.

The resin layer 121 may be formed of transparent material capable of transmitting lights, such as thermosetting resin or UV curable resin. For example, the resin layer 121 may be formed of polyurethane acrylate (PUA), or polydimethylsiloxane (PDMS).

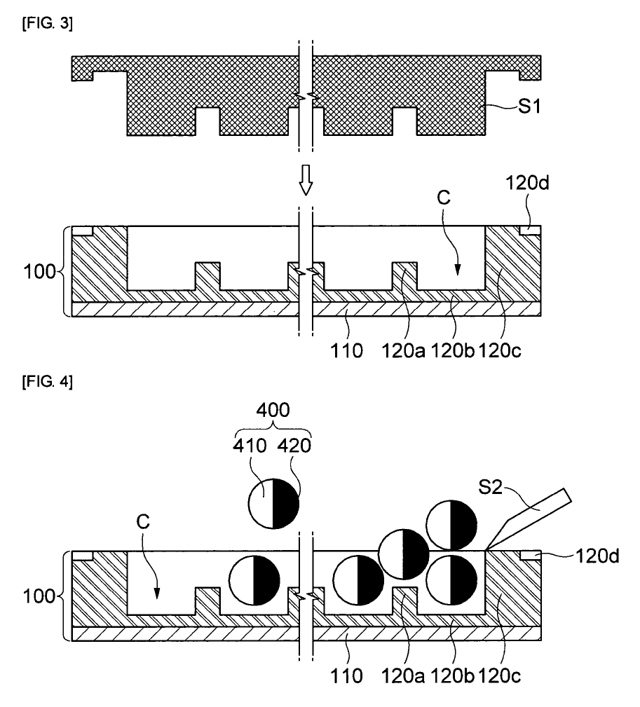

Referring to FIG. 3, the first partition wall 120a defining a number of cell regions is formed by using an imprint method. To be specific, a stamp S1 having a pattern opposite to a shape of the first partition wall 120a is provided on the resin layer 121. Herein, since one surface in which the resin layer 121 and the stamp S1 are in contact with each other has been subjected to a releasing processing, the stamp S1 can be easily separated from the partition wall after the first partition wall 120a is formed, and accordingly, the first partition wall 120a can be precisely formed. The releasing processing may be a process of forming a Self-Assemled-Monolayer (SAM) on one surface of the stamp S1.

Thereafter, the stamp S1 is pressed on the resin layer 121, and then the stamp S1 and the resin layer 121 come into close contact with each other. In this case, the resin layer 121 may be deformed to have a shape opposite to a shape of the pattern of the stamp S1. That is, the resin layer 121 may be deformed to be in the shape of the first partition wall 120a. Thereafter, by curing the deformed resin layer, it is possible to form the first partition wall 120a on the first electrode 110. In this case, when the resin layer 121 is formed of a UV curable resin, UV curing may be performed. Alternatively, when the resin layer 121 is formed of thermosetting resin, thermal curing may be performed. The stamp S1 is separated from the first partition wall 120a.

The stamp S1 further includes a pattern for formation of the first buffer layer 120b including the first partition wall 120a and the third partition wall 120c, thereby further forming the first buffer layer 120b and the third partition wall 120c in a step of forming the first partition wall 120a.

Herein, the first buffer layer 120b is formed on the first electrode 110 of the cell region defined by the first partition wall 120a so as to play a role of preventing the twist balls 400 and the first electrode 110 from being in direct contact with each other. Further, the third partition wall 120c is formed to have a height higher than that of the first partition wall 120a to play a role of allowing the upper substrate 200 to be separated apart from the lower substrate 100 at predetermined intervals. In this case, the third partition wall 120c may be formed along an edge of the first electrode 110. Further, the third partition wall 120c can play a role of preventing the dielectric fluid from flowing to an outside in a process of injecting the dielectric fluid 300 which is a following process.

The stamp S1 further includes a pattern for formation of a first align mark 120d, so that it is possible to further form the first align mark 120d in a step of forming the first partition wall 120a. The first align mark 120d may have various shapes such as a square shape, a circular shape, a cross shape, and so on, as viewed in a plan. However, the present invention is not limited thereto. Herein, the first align mark 120d may have a shape of a groove depending on a shape of the stamp S1. Further, the first align mark 120d may be formed to be at least two or more on an edge of the first electrode 110, that is, the third partition wall 120c.

Thus, the first electrode 110 and the first partition wall 120a are formed simultaneously while the third partition wall 120c and the first align mark 120d are formed, thereby forming the lower substrate 100.

Referring to FIG. 4, the twist balls 400 are individually injected in each of the cell regions C defined by the first partition wall 120a. After applying the twist balls 400 on the first electrode 110 including the first partition wall 120a, a squeegee S2 is provided on the first electrode 110 including the first partition wall 120a. Herein, the squeegee S2, or the first electrode 110 including the first partition wall 120a, that is, the lower substrate 100, is horizontally moved, so that the twist balls 400 can be injected in each of the cell regions C. In this case, the squeegee S2 is repeatedly transferred on the first partition wall 120a many times, so that a filling ratio of the twist balls 400 can be increased.

Referring to FIG. 5, the dielectric fluid 300 is injected into at least each of the cell regions including twist balls 400. That is, the dielectric fluid 300 is dropped on the first electrode 110 including the first partition wall 120a. Thus, the twist balls can be distributed in the dielectric fluid 300. That is, the twist balls 400 can be disposed to be in a state where they float within the dielectric fluid 300 of each of the cell regions C.

A liquid material, which is capable of converting lights in liquid phase, and has lubricant ingredients, e.g. Dow corning 10, Centistoke 200, and so on may be used as the dielectric fluid 300. In this case, it is possible to prevent an outflow of the dielectric fluid 300 by the third partition wall 120c.

Further, since the dielectric fluid 300 is not disposed in an area where it comes into contact with the upper substrate 200, it is possible to prevent adhesion reliability of the upper substrate 200 and the lower substrate 100 from being reduced due to the dielectric fluid.

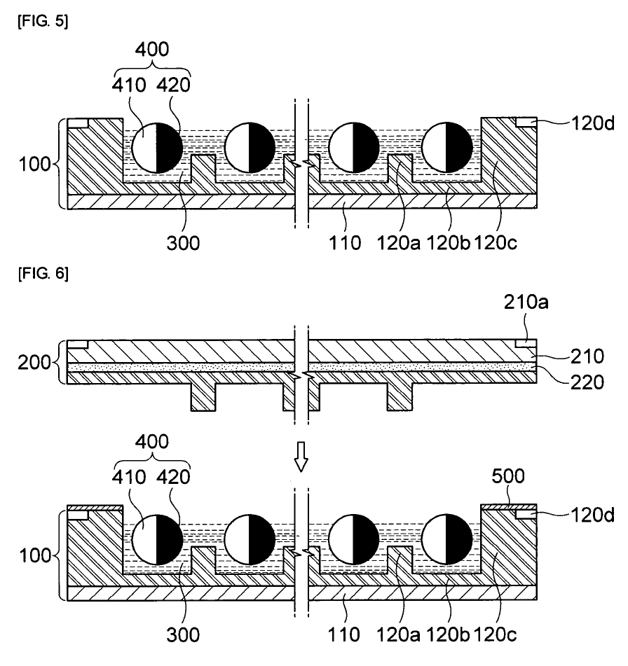

Referring to FIG. 6, the upper substrate 200 is provided on the lower substrate 100 having the twist balls 400 and the dielectric fluid 300 filled therein.

Herein, the upper substrate 200 can be formed in the same manner as in the process for forming the lower substrate 100. To be specific, in order to form the upper substrate 200, a resin layer is formed on the second electrode 220 disposed on the substrate 210. Thereafter, the second partition wall 230a corresponding to the first partition wall 120a is formed on the resin layer by using an imprint method. In the step of forming the second partition wall 230a, the second buffer layer 230b facing the first buffer layer 120b may be further formed. That is, the first buffer layer 120b is formed on the second electrode 220 defined by the second partition wall 230a, so that it is possible to play a role of preventing the second electrode 220 and the twist balls 400 from coming into direct contact with each other.

In addition, a second align mark 210a corresponding to the first align mark 120d may be formed on a rear surface of the substrate 210. The second align mark 210a can be formed by printing or applying a resin having a uniform color. Also, the second align mark 210a may be formed by attaching a tape having a uniform color.

Thereafter, the sealing member 500 is applied on an edge of the lower substrate 100, for example, on the third partition wall 120c. The sealing member 500 may be formed of UV curable resin. It has been illustrated and shown in the embodiment of the present invention that the sealing member 500 is formed on the lower substrate 100. However, the present invention is not limited thereto, and the sealing member 500 may be formed along an edge of the upper substrate 200. Also, the sealing member 500 may be further formed on the first partition wall 120a or the second partition wall 230a, as well as an edge of the upper substrate 200 or the lower substrate 100.

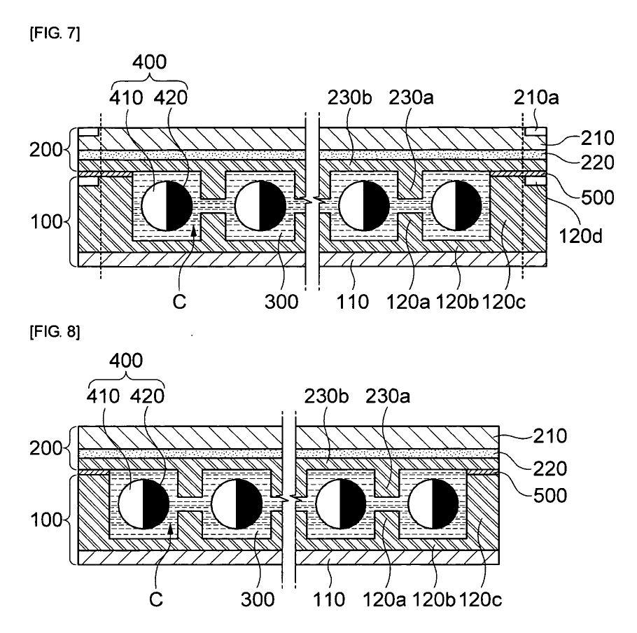

Referring to FIG. 7, the upper substrate 200 is bonded to the lower substrate 100 through the sealing member 500. In this case, the lower substrate 100 and the upper substrate 200 come into close contact with each other while the first align mark 120d and the second align mark 210a formed on each of the lower substrate 100 and the upper substrate 200 are being aligned. Thereafter, the sealing member 500 is subjected to UV curing, so that the upper substrate 200 and the lower substrate 100 can be bonded to each other. In this case, a process for aligning the upper and the lower substrates through the first align mark 120d and the second align mark 210a causes prevention of mis-alignment between the first partition wall 120a and the second partition wall 230a, when the lower substrate 100 is bonded to the upper substrate 200.

Also, in a process for bonding the lower substrate and the upper substrate through the first partition wall 120a and the second partition wall 230a, it is possible to prevent the twist balls 400 from being moved toward the neighboring cell regions C.

After the upper substrate 200 and the lower substrate 100 are boded to each other, it is possible to form the electronic paper display device by cutting the bonded substrates along a scribing line, as shown in FIG. 8.

Therefore, in the embodiment of the present invention, partition walls, buffer layers, and align marks are simultaneously formed through an imprint method, so that it is possible to more simplify the process.

Moreover, in the embodiment of the present invention, partition walls are formed on each of the upper substrate and the lower substrate, so that it is possible to overcome limitation of the aspect ratio of the partition walls.

Furthermore, in the embodiment of the present invention, it is possible to prevent mis-alignment between the first and second partition walls disposed on each of the upper substrate and the lower substrate, by a process for aligning the upper and lower substrates through align marks.

The electronic paper display device in accordance with the present invention is provided with partition walls for disposing twist balls, and thus the twist balls are uniformly arranged, resulting in improvement of its contrast ratio and prevention of inferior image quality.

Also, partition walls of the electronic paper display device in accordance with the present invention can prevent the twist balls from being moved when the first electrode and the second electrode come into contact with the twist balls, so that it is possible to prevent reduction of its contrast ratio.

Also, the electronic paper display device in accordance with the present invention is formed so that partition walls on each of the first electrode and the second electrode faces are faced to each other. The partition walls have a minimum width as well as a height enough to prevent departure of the twist balls. Therefore, it is possible to prevent reduction in its contrast ratio due to the partition walls.

Also, in an electronic paper display device in accordance with the present invention, dielectric fluid is filled in a region defined by partition walls, and thus it is unnecessary to separately coat dielectric fluid on an outer surface of the twist ball, resulting in more simplifying processes.

As described above, although the preferable embodiments of the present invention have been shown and described, it will be appreciated by those skilled in the art that substitutions, modifications and changes may be made in this embodiment without departing from the principles and spirit of the general inventive concept, the scope of which is defined in the appended claims and their equivalents.

1. An electronic paper display device comprising:
a first electrode;
a first partition wall which is disposed on the first electrode, and defines a number of cell regions;
a second partition wall which faces the first partition wall, and defines the cell regions together with the first partition wall;
a substrate including a second electrode, wherein the second electrode is disposed on the second partition wall, and faces the first electrode;
dielectric fluid filled in at least each of the cell regions; and
twist balls individually floating within the dielectric fluid of each of the cell regions.

2. The electronic paper display device of claim 1, further comprising a first buffer layer disposed on the first electrode of each of the cell regions, wherein the first buffer layer is integrated with the first partition wall.

3. The electronic paper display device of claim 1, further comprising a second buffer layer disposed on the second electrode of each of the cell regions, wherein the second buffer layer is integrated with the second partition wall.

4. The electronic paper display device of claim 1, further comprising a third partition wall disposed along periphery of the first electrode, wherein the third partition wall has a height higher than that of the first partition wall.

5. The electronic paper display device of claim 4, wherein the third partition wall is formed to have the same material as that of the first partition wall.

6. The electronic paper display device of claim 1, wherein the first and the second partition walls are separated apart from each other.

7. The electronic paper display device of claim 1, wherein the first and the second partition walls are in contact with each other.

8. The electronic paper display device of claim 1, wherein the first electrode is formed of a conductive substrate.

9. The electronic paper display device of claim 1, further comprising a substrate disposed on the second electrode.

10. A method for manufacturing an electronic paper display device comprising:
forming a first partition wall and a second partition wall, which define a number of cell regions, on each of a first electrode and a second electrode;
injecting twist balls on the first electrode of each of the cell regions defined by the first partition wall;
injecting dielectric fluid in at least each of the cell regions including the twist balls; and
bonding the first electrode having the first partition wall formed thereon and the second electrode having the second partition wall formed thereon so that the first partition wall and the second partition wall can be faced to each other.

11. The method of claim 10, wherein the first partition wall and the second partition wall are formed through an imprint method.

12. The method of claim 10, wherein, in forming the first partition wall, a first buffer layer is further formed on the first electrode of each of the cell regions defined by the first partition wall.

13. The method of claim 12, wherein, in forming the first partition wall, a third partition wall is further formed to have a height higher than that of the first partition wall, wherein the third partition wall is disposed along periphery of the first electrode.

14. The method of claim 12, wherein, in forming the first partition wall, a first align mark disposed on the third partition wall is further formed.

15. The method of claim 14, wherein a second align mark corresponding to the first align mark is formed on the substrate disposed on the second electrode.

16. The method of claim 10, wherein, in forming the second partition wall, the second buffer layer is further formed on the second electrode of each of the cell regions defined by the second partition wall.
